(19) United States
(12) Patent Application Publication
(10) Pub. No.: US 2022/0153069 A1
(43) Pub. Date: May 19, 2022

(54) METAMATERIAL BASED TIRE FOR QUIET CARS

(71) Applicant: UNIVERSITY OF NORTH TEXAS, DENTON, TX (US)

(72) Inventors: Hyeonu Heo, Denton, TX (US); Arup Neogi, Denton, TX (US)

(21) Appl. No.: 17/454,869

(22) Filed: Nov. 15, 2021

Related U.S. Application Data
(60) Provisional application No. 63/114,094, filed on Nov. 16, 2020.
(60) Provisional application No. 63/140,333, filed on Jan. 22, 2021.

(51) Int. Cl. B60C 19/00; B60C 5/00

(52) U.S. Cl. CPC B60C 19/002; B60C 5/002

(57) ABSTRACT

The disclosure relates to a road noise reducing system including a wheel rim having a barrel, a first layer of acoustic metamaterial with a first plurality of open cells mounted on the barrel, and, optionally, a second layer of acoustic metamaterial with a second plurality of open cells in contact with the first layer of acoustic metamaterial. The system optionally includes a pneumatic tire with a hollow, wherein the tire is mounted on the wheel rim such that the hollow forms a closed cavity and can incorporate additional elements including an elastomeric membrane, a noise-absorbing foam, and/or a resonator. The system has a sound transmission loss of at least 20-35 dB at frequencies of 50 Hz to 2,000 Hz and can reduce tire-road interaction noise by at least 50-70%. Also disclosed are methods of making road noise reducing wheel and tire assemblies, automobiles incorporating the same, and methods for reducing tire-road interaction noise.

### CROSS REFERENCE TO RELATED APPLICATIONS

This application claims the benefit of U.S. Provisional Application No. 63/114,094 filed on Nov. 16, 2020, and U.S. Provisional Application No. 63/140,333 filed on Jan. 22, 2021, both of which are incorporated herein by reference in their entireties.

### STATEMENT REGARDING FEDERALLY SPONSORED RESEARCH OR DEVELOPMENT

This invention was made with U.S. Government support under grant number NSF-EFMA-1741677 awarded by the National Science Foundation. The U.S. government has certain rights in the invention.

### BACKGROUND

Noise pollution from traffic is a widespread environmental problem and can cause sleep disturbances, hearing damage, even cardiovascular disease. The main sources of vehicle noise are the engine, the exhaust system, aeroacoustic noise, and tire-pavement interaction. Noise generated by the first three factors can be essentially reduced by replacing a combustion engine with an electric motor and optimizing aerodynamic design. The remaining factor is tire-pavement interaction, which accounts for up to 80-90% of road noise at speeds of 70-80 kph (43.5-49.7 mph) and up to 70% of road noise at speeds of 96.6 kph (60 mph). Any technique proposed to address this issue should consider the tire and wheel's structural and mechanical integrity, which can be problematic due to the tire cavity environment affected by the changes in loading conditions, speed, and temperature. To address noise pollution and to meet new governmental standards, tire and automobile manufacturers have been racing to develop “noiseless tires” applying soundproofing methods, e.g., resonators or sound absorbing materials. Currently, essential efforts are focused on suppression of the noise originating from the tire cavity resonance by filling the tire with sound absorbing foams or porous materials. However, these methods are limited to the narrow band or sound resonance of the tire cavity only.

Compressed air in a tire cavity generates a resonant noise and vibrations at frequencies below 1,000 Hz, typically between about 200 Hz and 250 Hz. Due to specific design constraints, general noise reduction methods, e.g., thick metal plates, are not applicable for use in tires. Some tire manufacturers add polyurethane absorber glued around the tire's inner liner to reduce noise, attach a resonator on the rim to reduce the resonance sound of the tire cavity, and/or optimize the pitch arrangement of the tire tread patterns to minimize noise from the source. Polyurethane absorbers are effective at eliminating about 5-7 dB of noise from tire-pavement interaction. Resonators tuned to the tire cavity mode can reduce an additional 10-15 dB of noise, while tread design results in less than about 10 dB of noise reduction. Active noise control using an inverted sound wave has also been proposed and may result in about 3 dB of reduction. However, these efforts are mainly focused on the resonator for the tire cavity resonance, i.e., a narrow band, and/or the sound absorption capability of porous materials. Additionally, such solutions may add weight to tires, decreasing vehicle performance. Furthermore, tire-pavement interaction can typically reach close to 60 dB, so even combinations of the aforementioned solutions leave the problem only partially solved.

Despite advances in the reduction of noise from tire-pavement interaction, current technology suffers from numerous drawbacks and limitations as outlined above. What is needed is a structure having broad noise reduction capability and that possesses high reflective and absorbing characteristics while remaining lightweight. It would be advantageous if the structure is easy to fabricate and does not require general design changes to a tire. It would further be advantageous if the structure could be directly applied to the wheel or tire assembly of any car or motor vehicle. The present disclosure addresses these needs.

### SUMMARY

In accordance with the purpose(s) of the present disclosure, as embodied and broadly described herein, the disclosure, in one aspect, relates to a road noise reducing system that includes a wheel rim having a barrel, a first layer of acoustic metamaterial with a first plurality of open cells mounted on the barrel, and, optionally, a second layer of acoustic metamaterial with a second plurality of open cells in contact with the first layer of acoustic metamaterial. In another aspect, the road noise reducing system further includes a pneumatic tire with a hollow, wherein the tire is mounted on the wheel rim such that the hollow forms a closed cavity. The road noise reducing system can optionally incorporate additional elements including, but not limited to, an elastomeric thin plate or membrane, a noise-absorbing foam, and/or a hollow resonator. The road noise reducing system has a sound transmission loss of at least 20-35 dB or more at frequencies under 500 Hz as well as similar values for sound transmission loss at frequencies between 500 Hz and 2,000 Hz and can reduce tire-road interaction noise by at least 50-70% or more compared to a control not using the road noise reducing system. Also disclosed are methods of making road noise reducing wheel and tire assemblies, automobiles incorporating the same, and methods for reducing tire-road interaction noise.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows an illustration of an acoustic metasurface consisting of a honeycomb core panel and elastomeric thin plate or membrane on a tire rim.

FIG. 2 shows a tire cavity model (left) representing a real tire (235/65 R18), where Dₒ=30 in. and Dᵢ=18 in., respectively. The thickness values of Al sheets, MDF, and acrylic panel, are 0.060 in., 0.750 in., and 0.437 in., respectively. At the bottom, there is a hole to generate the white noise to represent tire-pavement interaction noise using a speaker. Six electret microphones were mounted equidistant along the azimuthal direction in the outer cavity, while two electret microphones were attached in the inner cavity. The rim of the tire (Pirelli Tire) 185/65R15 from a Toyota Prius Hybrid 2008 vehicle is shown on the right. The foam and the acoustic metasuface (AMS) were bonded on the circumference of the rim, 3.5 in. width. The density of foam and AMS are approximately 161 kg/m³ and 233 kg/m³, respectively.

FIG. 3 shows the results of a parametric study on design parameters including thickness and radius of elastomeric thin plate or membrane.

FIG. 4 shows the results of a study of sound pressure level in a tire cavity model.

FIG. 5 shows the results of sound reduction performance of acoustic metamaterials (dark solid line) and foam (dashed line) compared to the original tire (light solid line) without any attachment through a field test.

FIG. 6 is a diagram showing placement of acoustic metamaterial in a tubeless automobile tire in one exemplary embodiment of the present disclosure.

FIG. 7 shows sound transmission loss versus frequency for an acoustic metamaterial with elastomeric thin plate or membrane according to one exemplary embodiment of the present disclosure.

FIG. 8 shows effective dynamic mass density of an acoustic metamaterial with elastomeric thin plate or membrane according to one exemplary embodiment of the present disclosure having a circular-shaped unit cell. The fundamental resonance of the thin plate in this example is at 1,634 Hz. The effective mass density is negative when the frequency is less than this resonance.

FIG. 9 shows effective dynamic mass density of an acoustic metasurface with elastomeric thin plate according to a second exemplary embodiment of the present disclosure having a hexagonal-shaped unit cell. The fundamental resonance of the thin plate in this example is at 2,056 Hz. The effective mass density is negative when the frequency is less than this resonance.

FIGS. 10A-10C show the results of a parametric study on design parameters, such as thickness (hₘ), and side length (aₘ), of the thin plate of hexagonal unit cells of AMSes. FIG. 10A: The schematic image of the unit cell used for the numerical simulation. FIG. 10B: The unit cell's natural frequency, the clamped circular plate, calculated using Equations 1 and 2. FIG. 10C: sound transmission loss (STL) calculated by the numerical simulation.

FIG. 11A shows sound pressure level and FIGS. 11C-11D show normalized sound transmission coefficients in a tire cavity model measured in the inner cavity. The background noise (black solid lines) is shown for reference. The light solid lines represent the white noise (W.N.) when the speaker is turned on. The dark gray solid or dashed and gray solid or dotted lines are the cases of attached foam and AMS, respectively. FIG. 11B shows cavity models with foam or AMS utilized in this experiment.

FIGS. 12A-12F show results of the sound reduction performance of AMS (light dotted lines) and foam (dashed lines) comparing to the original tire (light solid lines) without any attachment through the field test. FIG. 12A shows sound pressure spectra from 100 Hz to 1,000 Hz. The solid black line is the case of the stopped state. At 60 mph, light (solid), dark gray (dashed), and light (dotted) lines represent the cases of without any attachment, foam, and AMS on the rim, respectively. FIGS. 12B-12F show the normalized sound transmission coefficients (N-STC) from 200 Hz to 300 Hz depending on the vehicle speed. STC is normalized by the peak of the cavity mode at 60 mph.

FIG. 13 shows an exemplary resonator mounted on a wheel according to one aspect of the present disclosure.

FIGS. 14A-14C show various cross-sectional views of a tire including exemplary configurations of an AMM with optional resonator and/or foam.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “an open cell,” “an elastomer,” or “an acoustic metamaterial,” including, but not limited to, combinations or mixtures of two or more such open cells, elastomers, or acoustic metamaterials, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

As used herein, a “metamaterial” is a material that has been engineered to have a property that is not found in a naturally occurring material. The shape, geometry, size, orientation, and/or arrangement of metamaterials can be varied to impart desired properties including, but not limited to, invisibility, inaudibility, impalpability, and the like. In one aspect, the road noise reducing systems and tire and wheel assemblies disclosed herein incorporate acoustic metamaterials that significantly reduce noise caused by tire-pavement interaction.

As used herein, an “elastomer” is a viscoelastic polymer that can be stretched as much as twice its original length without being permanently deformed. In one aspect, elastomers can be crosslinked and have glass transition temperatures below room temperature. In another aspect, elastomers have a low Young's modulus. In some aspects, the road noise reducing systems disclosed herein include an elastomeric thin plate or membrane in contact with an acoustic metamaterial.

A “resonator” as used herein refers to a device for reducing tire noise. In one aspect, a resonator can be fitted to a groove in the barrel of a wheel rim. In one aspect, the resonator can be hollow and may be vented. A resonator can, in some aspects, generate the same frequency as pipe resonance generated by a tire. When resonance occurs, air disturbance near the resonator vent(s) causes vibrations and air passes through the resonator, which in turn cancels the tire pipe resonance sound.

“Sound transmission loss” as used herein refers to the ability of a material to prevent airborne sound transmission from moving from one space to another, and is a quantification of how much sound energy of a given frequency is prevented from traveling through the material.

Unless otherwise specified, temperatures referred to herein are based on atmospheric pressure (i.e., one atmosphere).

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### Road Noise Reducing System

In one aspect, tire cavity noise arises when variation of pressure inside a rolling tire activates the compressed air within the tire cavity. In another aspect, following activation of the compressed air, the tire cavity resonates, and the wheel begins to vibrate. In a still further aspect, these vibrations can reach the vehicle interior, causing occupants of the vehicle to perceive an audible buzz called cavity noise.

In one aspect, disclosed herein is a road noise reducing system that can reduce the amount of cavity noise experienced by passengers in a vehicle. In a further aspect, the noise reducing system includes a pneumatic tire with a hollow, a wheel rim having a barrel, a first layer of acoustic metamaterial having a first plurality of open cells mounted on the barrel and, optionally, a second layer of acoustic metamaterial having a second plurality of open cells in contact with the first layer of acoustic metamaterial, wherein the tire is mounted on the wheel rim such that the hollow forms a closed cavity.

In one aspect, the road noise reducing system disclosed herein is useful for and can be installed on any motorized vehicle having a passenger cavity that experiences noise from tire-road interaction. The road noise reducing system disclosed herein incorporates thin and lightweight acoustic metamaterials that can be fitted or installed on any diameter or wheel width.

### Properties of Acoustic Metamaterial

In one aspect, the first layer of acoustic metamaterial, the second layer of acoustic metamaterial, if present, or both, are constructed from a meta-aramid paper. In another aspect, the meta-aramid paper can be coated or impregnated with a phenolic resin.

In another aspect, the first and/or second layers of acoustic metamaterial both independently have a thickness of from about ⅛ in (3.2 mm) to about 2 in (50.8 mm), or from about ⅛ in (3.2 mm) to about ½ in (12.8 mm), or of about ⅛, ¼, ⅜, ½, ¾, 1, 1.25, 1.5, 1.75, or about 2 in, or a combination of any of the foregoing values, or a range encompassing any of the foregoing values. In one aspect, the thickness is about ¼ in (6.4 mm). In one aspect, the first and/or second layers of acoustic metamaterial are the same. In another aspect, the first and/or second layers of acoustic metamaterial differ in one or more of shape, size, and thickness. Without wishing to be bound by theory, different cell shapes, sizes, and thicknesses in acoustic metamaterials can be combined in the first and second layers to control noise in different frequency ranges and can be selected based on expected operating conditions.

In one aspect, the first and/or second layers of acoustic metamaterial both independently have a density of from about 1.5 pcf (24 kg/m³) to about 16 pcf (257 kg/m³), or of about 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, or about 16 pcf, or a combination of any of the foregoing values, or a range encompassing any of the foregoing values. In another aspect, traditionally, materials providing high sound transmission loss are quite heavy and dense. However, the disclosed acoustic metamaterials are lightweight and thus do not negatively affect vehicle performance (e.g., gas mileage) when installed.

In one aspect, the first and/or second plurality of open cells both have a triangular shape, a square shape, a circular shape, a hexagonal shape, a rectangular shape, or any combination thereof. In another aspect, the first and/or second plurality of open cells has a cell size of from about ⅛ in (3.2 mm) to about ⅜ in (9.6 mm), or of about ⅛, ¼, or about ⅜ in, or a combination of any of the foregoing values, or a range encompassing any of the foregoing values. In one aspect, the first and/or second plurality of open cells has a hexagonal shape and a cell size of about ⅛ in.

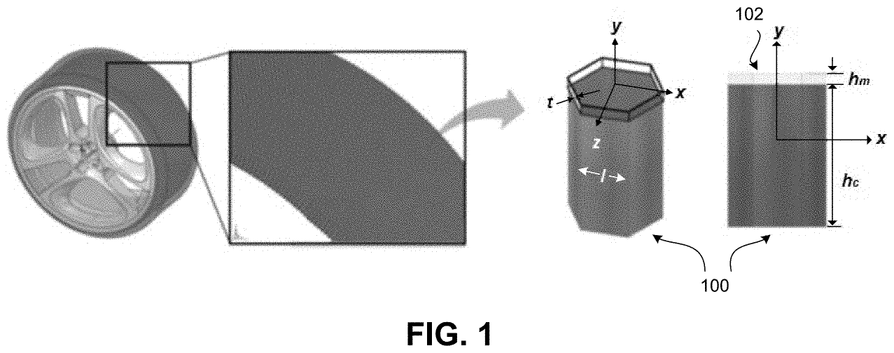

In one aspect, the first and/or second plurality of cells have a hexagonal shape. Further in this aspect, the cells having a hexagonal shape have a side length per cell (element/in FIG. 1) of from about 1 mm to about 10 mm, or of about 1, 2, 3, 4, 5, 6, 7, 8, 9, or about 10 mm, or a combination of any of the foregoing values, or a range encompassing any of the foregoing values. In one aspect, the side length per cell is about 3.65 mm.

### Elastomeric Membrane

In some aspects, the road noise reducing system disclosed herein includes a thin elastomeric membrane or plate. In a further aspect, addition of the thin elastomeric membrane or plate can further enhance noise reduction capabilities of the acoustic metamaterials as measured by properties such as, for example, sound transmission loss. FIG. 1 (rightmost image) provides a non-limiting example of the arrangement of acoustic metamaterial and elastomeric membrane with membrane 102 and honeycomb AMM wall 100. An acoustic metasurface is shown in the expanded inset (leftmost image).

In another aspect, the elastomeric membrane can be selected from silicone, a natural latex, a synthetic latex, neoprene, ethylene propylene diene monomer (EPDM) rubber, nitrile, styrene-butadiene rubber (SBR), natural rubber, polyurethane, a fluoroelastomer, isobutylene-isoprene, or any combination thereof.

In still another aspect, the elastomeric membrane or plate has a thickness of from about 0.5 mm to about 2 mm, or of about 0.5, 0.75, 1, 1.25, 1.5, 1.75, or about 2 mm, or a combination of any of the foregoing values, or a range encompassing any of the foregoing values. In one aspect, the elastomeric membrane is about 1 mm thick.

In any of these aspects, the elastomeric membrane can be applied as an uncured elastomer to the acoustic metamaterial. Further in this aspect, the uncured elastomer can be cured at room temperature. Still further in this aspect, following curing, the cured elastomer is bonded to the acoustic metamaterial. In one aspect, the elastomeric membrane can be on top of the acoustic metamaterial, that is, the membrane is located such that, in an assembled and inflated tire, the membrane is exposed to the air in the tire.

In one aspect, the elastomeric membrane or plate has a Young's modulus of from about 10⁻⁴ GPa to about 10⁻¹ GPa, or from about 5 MPa to about 10 MPa, or of about 5, 6, 7, 8, 9, or about 10 MPa, or a combination of any of the foregoing values, or a range encompassing any of the foregoing values. In one aspect, the Young's modulus is about 7 MPa.

### Additional Components

In one aspect, the noise reducing system disclosed herein can include additional components. In one aspect, the noise reducing system includes a noise-absorbing foam in the hollow of the pneumatic tire. In another aspect, the noise-absorbing foam can be a polyurethane foam.

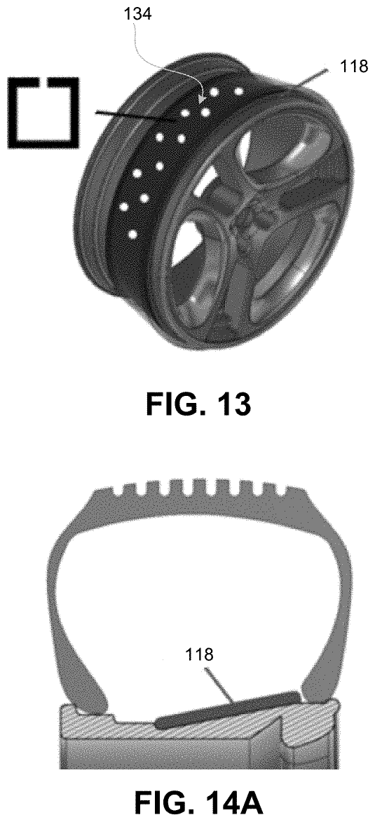

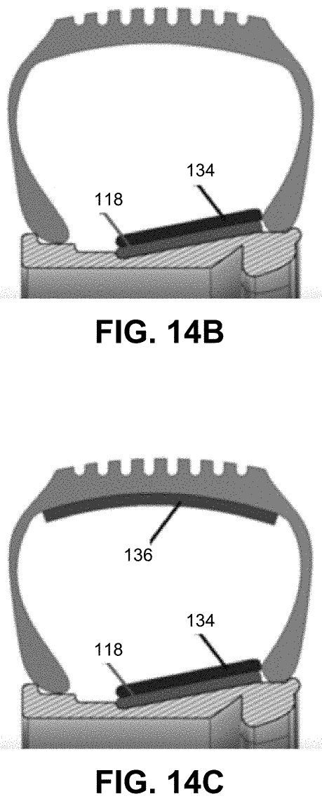

In a further aspect, the barrel of the wheel rim can include a groove. Further in this aspect, a resonator can be mounted in the groove. In some aspects, the resonator is hollow and includes at least one vent. In another aspect, the first layer of acoustic metamaterial contacts the resonator. Exemplary configurations are provided in FIGS. 13 and 14A-14C. Turning to FIG. 13, AMM 118 is shown under resonator 134, with a cross sectional representation of resonator 134 shown in the expanded inset (top left). FIG. 14A shows a cross section of an exemplary tire and wheel showing one placement of AMM 118. In FIG. 14B, AMM 118 is in contact with resonator 134. Finally, in FIG. 13C, AMM 118 and resonator 134 are present in an exemplary tire also including foam 136.

### Road Noise Reduction

In one aspect, the road noise reducing system has a sound transmission loss of at least 20, 25, 30, or 35 dB at frequencies of from about 500 to about 2,000 Hz, or under about 500 Hz, or a combination of any of the foregoing values, or a range encompassing any of the foregoing values.

In another aspect, the road noise reducing system has an effective dynamic mass density of less than about 0 kg/m³ at frequencies of from about 50 Hz to about 2,000 Hz.

In another aspect, the road noise reducing system reduces tire-road interaction noise by at least about 50%, at least about 60%, or at least about 70% compared to not using the road noise reducing system, or a combination of any of the foregoing values, or a range encompassing any of the foregoing values.

### Method for Reducing Tire-Road Interaction Noise

In one aspect, disclosed herein is a method for reducing tire-road interaction noise, the method including at least the steps of installing the disclosed road noise reducing system on an automobile and driving the automobile. In one aspect, 1, 2, 3, or 4 wheel and tire assemblies on the automobile can be replaced with the disclosed road noise reducing system. Also disclosed herein are automobiles equipped with the disclosed road noise reducing system.

### Method for Making a Road Noise Reducing Wheel and Tire Assembly

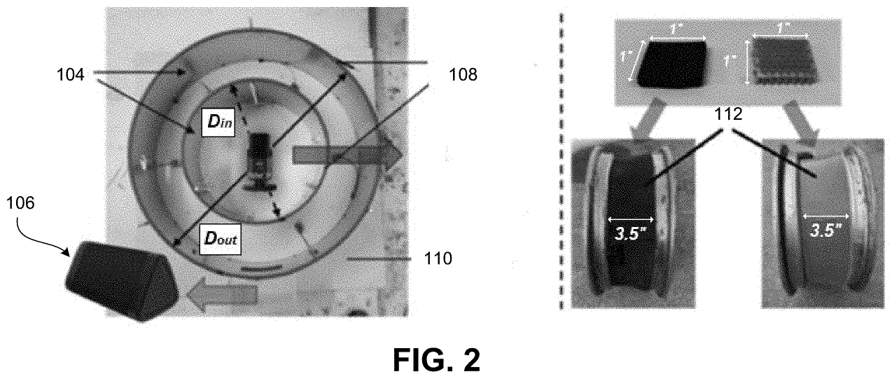

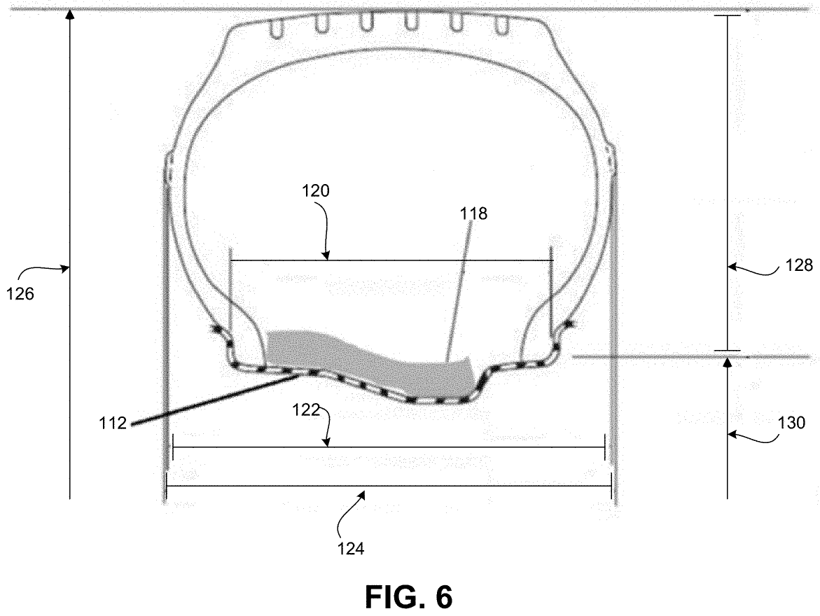

In some aspects, the wheels disclosed herein include a barrel. Further in this aspect, a “barrel” as used herein refers to an outer portion of the wheel rim that creates structures necessary for mounting a tire. In one aspect, the barrel can be flat, or can be grooved or otherwise shaped to enhance placement and security of the tire. A non-limiting example of a barrel cross-section is provided in FIG. 6. Additional non-limiting examples of top views of barrels to which AMMs have been applied are presented in FIG. 2 (right panel).

In another aspect, disclosed herein is a method for making a road noise reducing wheel and tire assembly, the method including the steps of (a) providing a wheel rim having a barrel, (b) contacting the barrel with a first layer of acoustic metamaterial having a first plurality of open cells mounted on the barrel; (c) optionally, contacting the first layer of acoustic metamaterial with a second layer of acoustic metamaterial having a second plurality of open cells. In some aspects, the method further includes the steps of: (d) mounting a pneumatic tire having a hollow in the wheel rim such that the hollow forms a closed cavity; and (e) inflating the tire. In some aspects, the method further includes step (f), of contacting the first and/or second layers of acoustic metamaterial with an elastomeric membrane as disclosed herein.

In another aspect, the method further includes step (g), of installing a noise-absorbing foam in the hollow of the pneumatic tire. In some aspects, when the barrel of the wheel rim includes a groove, the method includes step (h), mounting a resonator in the groove, wherein the resonator contacts the first layer of acoustic metamaterial. In one aspect, the noise-absorbing foam can be a commercial polyurethane foam.

Also disclosed herein are road noise reducing wheel and tire assemblies constructed according to the disclosed method.

### ASPECTS

The present disclosure can be described in accordance with the following numbered aspects, which should not be confused with the claims.

Aspect 1. A road noise reducing system comprising:
(a) a wheel rim comprising a barrel;
(b) a first layer of acoustic metamaterial comprising a first plurality of open cells mounted on the barrel; and
(c) optionally, a second layer of acoustic metamaterial comprising a second plurality of open cells in contact with the first layer of acoustic metamaterial.

Aspect 2. The road noise reducing system of aspect 1, further comprising:
(d) a pneumatic tire comprising a hollow,
wherein the tire is mounted on the wheel rim such that the hollow forms a closed cavity.

Aspect 3. The road noise reducing system of aspect 1 or 2, wherein the first layer of acoustic metamaterial, the second layer of acoustic metamaterial if present, or both comprise a meta-aramid paper.

Aspect 4. The road noise reducing system of aspect 3, wherein the first layer of acoustic metamaterial, the second layer of acoustic metamaterial if present, or both comprise a phenolic resin.

Aspect 5. The road noise reducing system of any one of aspects 1-4, wherein the first layer of acoustic metamaterial, the second layer of acoustic metamaterial if present, or both independently have a thickness of from about ⅛ in (3.2 mm) to about 2 in (50.8 mm).

Aspect 6. The road noise reducing system any of aspects 1-4, wherein the first layer of acoustic metamaterial, the second layer of acoustic metamaterial if present, or both independently have a thickness of from about ⅛ (3.2 mm) in to about ½ in (12.8 mm).

Aspect 7. The road noise reducing system any of aspects 1-4, wherein the first layer of acoustic metamaterial, the second layer of acoustic metamaterial if present, or both have a thickness of about ¼ in (6.4 mm).

Aspect 8. The road noise reducing system of any one of aspects 1-7, wherein the first layer of acoustic metamaterial, the second layer of acoustic metamaterial if present, or both independently have a density of from about 1.5 pcf (24 kg/m³) to about 16 pcf (257 kg/m³).

Aspect 9. The road noise reducing system of any one of aspects 1-8, wherein the first plurality of open cells, the second plurality of open cells if present, or both comprise unit cells having a triangular shape, a square shape, a circular shape, a hexagonal shape, a rectangular shape, or any combination thereof.

Aspect 10. The road noise reducing system of any one of aspects 1-8, wherein the first plurality of open cells, the second plurality of open cells if present, or both comprise unit cells having a hexagonal shape.

Aspect 11. The road noise reducing system of aspect 10, wherein the unit cells comprise a side length of from about 1 mm to about 10 mm.

Aspect 12. The road noise reducing system of aspect 10, wherein the unit cells comprise a side length of from about 3.65 mm.

Aspect 13. The road noise reducing system of any one of aspects 1-12, wherein the first plurality of open cells, the second plurality of open cells if present, or both comprise a cell size of from about ⅛ in (3.2 mm) to about ⅜ in (9.6 mm).

Aspect 14. The road noise reducing system of any one of aspects 1-12, wherein the first plurality of open cells, the second plurality of open cells if present, or both comprise a cell size of about ⅛ in (3.2 mm).

Aspect 15. The road noise reducing system of any one of aspects 1-14, wherein the first layer of acoustic metamaterial and the second layer of acoustic metamaterial differ in one or more of thickness, density, unit cell shape, side length, and cell size.

Aspect 16. The road noise reducing system of any one of aspects 1-14, wherein the first layer of acoustic metamaterial and the second layer of acoustic metamaterial are identical materials.

Aspect 17. The road noise reducing system of any one of aspects 1-16, further comprising an elastomeric membrane.

Aspect 18. The road noise reducing system of aspect 17, wherein the elastomeric membrane comprises silicone, a natural latex, a synthetic latex, neoprene, ethylene propylene diene monomer (EPDM) rubber, nitrile, styrene-butadiene rubber (SBR), natural rubber, polyurethane, a fluoroelastomer, isobutylene-isoprene, or any combination thereof.

Aspect 19. The road noise reducing system of aspect 18, wherein the elastomeric membrane has a thickness of from about 0.5 mm to about 2 mm.

Aspect 20. The road noise reducing system of aspect 18, wherein the elastomeric membrane has a thickness of about 1 mm.

Aspect 21. The road noise reducing system of any one of aspects 17-20, wherein the elastomeric membrane has a Young's modulus of from about 10⁻⁴ GPa to about 10⁻¹ GPa.

Aspect 22. The road noise reducing system of any one of aspects 17-20, wherein the elastomeric membrane has a Young's modulus of about 7 MPa.

Aspect 23. The road noise reducing system of any one of aspects 1-22, wherein the road noise reducing system has an effective dynamic mass density of less than about 0 kg/m³ at frequencies of from about 50 Hz to about 2,000 Hz.

Aspect 24. The road noise reducing system of any one of aspects 2-23, further comprising a noise-absorbing foam in the hollow of the pneumatic tire.

Aspect 25. The road noise reducing system of aspect 24, wherein the noise-absorbing foam comprises a polyurethane foam.

Aspect 26. The road noise reducing system of any one of aspects 1-25, wherein the barrel of the wheel rim further comprises a groove.

Aspect 27. The road noise reducing system of aspect 26, further comprising a resonator mounted in the groove.

Aspect 28. The road noise reducing system of aspect 27, wherein the resonator is hollow.

Aspect 29. The road noise reducing system of aspect 27 or 28, wherein the resonator comprises at least one vent.

Aspect 30. The road noise reducing system of any one of aspects 27-29, wherein the first layer of acoustic metamaterial contacts the resonator.

Aspect 31. The road noise reducing system of any one of aspects 1-30, wherein the road noise reducing system has a sound transmission loss of at least 20 dB at frequencies of from about 50 Hz to about 2,000 Hz.

Aspect 32. The road noise reducing system of any one of aspects 1-30, wherein the road noise reducing system has a sound transmission loss of at least 30 dB at frequencies of from about 50 Hz to about 2,000 Hz

Aspect 33. The road noise reducing system of any one of aspects 1-30, wherein the road noise reducing system has a sound transmission loss of at least 40 dB at frequencies of from about 50 Hz to about 2,000 Hz.

Aspect 34. The road noise reducing system of any one of aspects 1-30, wherein the road noise reducing system has a sound transmission loss of at least 50 dB at frequencies of from about 50 Hz to about 2,000 Hz.

Aspect 35. The road noise reducing system of any one of aspects 1-34, wherein tire-road interaction noise is reduced by at least about 50% compared to a control not using the road noise reducing system.

Aspect 36. The road noise reducing system of any one of aspects 1-34, wherein tire-road interaction noise is reduced by at least about 60% compared to a control not using the road noise reducing system.

Aspect 37. The road noise reducing system of any one of aspects 1-34, wherein tire-road interaction noise is reduced by at least about 70% compared to a control not using the road noise reducing system.

Aspect 38. A method for reducing tire-road interaction noise, the method comprising installing the road noise reducing system of any one of aspects 1-37 on an automobile and driving the automobile.

Aspect 39. The method of aspect 38, wherein from one to four wheel and tire assemblies on the automobile are replaced with the road noise reducing system of any one of aspects 1-37.

Aspect 40. An automobile equipped with the road noise reducing system of any one of aspects 1-37.

Aspect 41. A method for making a road noise reducing wheel and tire assembly, the method comprising:
(a) providing a wheel rim comprising a barrel;
(b) contacting the barrel with a first layer of acoustic metamaterial comprising a first plurality of open cells mounted on the barrel; and
(c) optionally, contacting the first layer of acoustic metamaterial with a second layer of acoustic metamaterial comprising a second plurality of open cells.

Aspect 42. The method of aspect 41, further comprising:
(d) mounting a pneumatic tire comprising a hollow on the wheel rim such that the hollow forms a closed cavity; and
(e) inflating the tire.

Aspect 43. The method of aspect 41, wherein the first layer of acoustic metamaterial, the second layer of acoustic metamaterial if present, or both comprise a meta-aramid paper.

Aspect 44. The method of aspect 43, wherein the first layer of acoustic metamaterial, the second layer of acoustic metamaterial if present, or both comprise a phenolic resin.

Aspect 45. The method of any one of aspects 41-44, wherein the first layer of acoustic metamaterial, the second layer of acoustic metamaterial if present, or both independently have a thickness of from about ⅛ in (3.2 mm) to about 2 in (50.8 mm).

Aspect 46. The method of any one of aspects 41-44, wherein the first layer of acoustic metamaterial, the second layer of acoustic metamaterial if present, or both independently have a thickness of from about ⅛ in (3.2 mm) to about ½ in (12.8 mm).

Aspect 47. The method of any one of aspects 41-44, wherein the first layer of acoustic metamaterial, the second layer of acoustic metamaterial if present, or both have a thickness of about ¼ in (6.4 mm).

Aspect 48. The method of any one of aspects 41-47, wherein the first layer of acoustic metamaterial, the second layer of acoustic metamaterial if present, or both independently have a density of from about 1.5 pcf (24 kg/m³) to about 16 pcf (257 kg/m³).

Aspect 49. The method of any one of aspects 41-48, wherein the first plurality of open cells, the second plurality of open cells if present, or both comprise unit cells having a triangular shape, a square shape, a circular shape, a hexagonal shape, a rectangular shape, or any combination thereof.

Aspect 50. The method of any one of aspects 41-48, wherein the first plurality of open cells, the second plurality of open cells if present, or both comprise unit cells having a hexagonal shape.

Aspect 51. The method of aspect 50, wherein the unit cells have a side length of from about 1 mm to about 10 mm.

Aspect 52. The method of aspect 50, wherein the unit cells have a side length of from about 3.65 mm.

Aspect 53. The method of any one of aspects 41-52, wherein the first plurality of open cells, the second plurality of open cells if present, or both comprise a cell size of from about ⅛ in (3.2 mm) to about ⅜ in (9.6 mm).

Aspect 54. The method of any one of aspects 41-52, wherein the first plurality of open cells, the second plurality of open cells if present, or both comprise a cell size of about ⅛ in (3.2 mm).

Aspect 55. The road noise reducing system of any one of aspects 39-54, wherein the first layer of acoustic metamaterial and the second layer of acoustic metamaterial differ in one or more of thickness, density, unit cell shape, side length, and cell size.

Aspect 56. The road noise reducing system of any one of aspects 39-54, wherein the first layer of acoustic metamaterial and the second layer of acoustic metamaterial are identical materials.

Aspect 57. The method of any one of aspects 39-56, further comprising:
(f) contacting the first layer of acoustic metamaterial, the second layer of acoustic metamaterial if present, or both with an elastomeric material; and
(g) curing the elastomeric material to form an elastomeric membrane.

Aspect 58. The method of aspect 57, wherein the elastomeric membrane comprises silicone, a natural latex, a synthetic latex, neoprene, ethylene propylene diene monomer (EPDM) rubber, nitrile, styrene-butadiene rubber (SBR), natural rubber, polyurethane, a fluoroelastomer, isobutylene-isoprene, or any combination thereof.

Aspect 59. The method of aspect 58, wherein the elastomeric membrane has a thickness of from about 0.5 mm to about 2 mm.

Aspect 60. The method of aspect 58, wherein the elastomeric membrane has a thickness of about 1 mm.

Aspect 61. The method of any one of aspects 57-60, wherein the elastomeric membrane has a Young's modulus of from about 5 MPa to about 10 MPa.

Aspect 62. The method of any one of aspects 57-60, wherein the elastomeric membrane has a Young's modulus of about 7 MPa.

Aspect 63. The method of any one of aspects 41-62, wherein the road noise reducing system has an effective dynamic mass density of less than about 0 kg/m³ at frequencies of from about 500 Hz to about 2000 Hz.

Aspect 64. The method of any one of aspects 41-63, further comprising:
(h) installing a noise-absorbing foam in the hollow of the pneumatic tire.

Aspect 65. The method of aspect 64, wherein the noise-absorbing foam comprises a polyurethane foam.

Aspect 66. The method of any one of aspects 41-65, wherein the barrel of the wheel rim further comprises a groove.

Aspect 67. The method of aspect 66, further comprising:
(i) mounting a resonator in the groove, wherein the resonator contacts the first layer of acoustic metamaterial.

Aspect 68. The method of aspect 67, wherein the resonator is hollow.

Aspect 69. The method of aspect 67 or 68, wherein the resonator comprises at least one vent.

Aspect 70. A wheel and tire assembly produced by the method of any one of aspects 41-69.

Aspect 71. The wheel and tire assembly of aspect 70, wherein the wheel and tire assembly has a sound transmission loss of at least 20 dB at frequencies of from about 50 Hz to about 2,000 Hz.

Aspect 72. The wheel and tire assembly of aspect 70, wherein the wheel and tire assembly has a sound transmission loss of at least 30 dB at frequencies of from about 50 Hz to about 2,000 Hz.

Aspect 73. The wheel and tire assembly of aspect 70, wherein the wheel and tire assembly has a sound transmission loss of at least 40 dB at frequencies of from about 50 Hz to about 2,000 Hz.

Aspect 74. The wheel and tire assembly of aspect 70, wherein the wheel and tire assembly has a sound transmission loss of at least 50 dB at frequencies of from about 50 Hz to about 2,000 Hz.

Aspect 75. The wheel and tire assembly of any one of aspects 70-74, wherein tire-road interaction noise is reduced by at least about 50% compared to a control not using the wheel and tire assembly.

Aspect 76. The wheel and tire assembly of any one of aspects 70-74, wherein tire-road interaction noise is reduced by at least about 60% compared to a control not using the wheel and tire assembly.

Aspect 77. The wheel and tire assembly of any one of aspects 70-74, wherein tire-road interaction noise is reduced by at least about 70% compared to a control not using the wheel and tire assembly.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Numerical Simulation

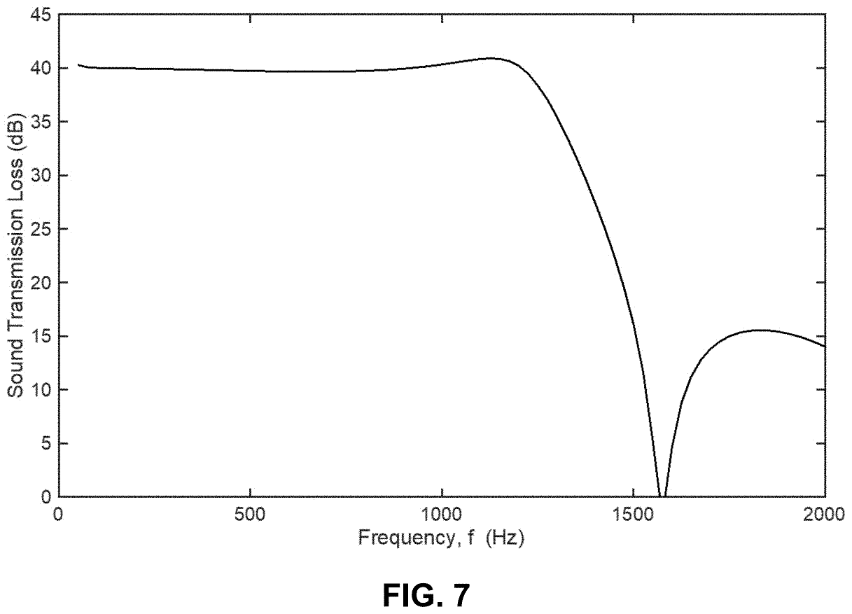

Highly reflective AMMs are shown in FIG. 1, where t represents the thickness of an AMM cell wall, I represents the length of an AMM cell edge, hₘ represents the height of an elastomeric membrane in contact with the AMM, and h_{c} represents the thickness of the core panel. The acoustic metamaterial is made up of commercial honeycomb core panel and silicone rubber. The parametric study for the unit cell was performed through numerical simulation (acoustic module) to predict the effect of design parameters on acoustic properties. The parametric study for the unit cell was performed through numerical simulation using the acoustic module of COMSOL in order to predict the effect of sound pressure loss. Even though the material properties of honeycomb core panel and silicone rubber were simplified in this study, the AMM shows substantial noise reduction of 22-35 dB. A smaller unit cell and a thicker membrane have even higher sound losses. One layer of such panel is a metasurface with strong reflection in deeply subwavelength region. FIG. 7 shows sound transmission loss for an AMM with membrane and several numerical simulations.

### Example 2: Model Tire Cavity

To demonstrate noise reduction effect, a model of tire cavity representing a real tire (235/65 R18) was constructed as shown in FIG. 2. The model consisted of medium-density fiberboard 110, aluminum metal sheets 104, rubber seals 108, and acrylic panel (transparent, not shown). The outer and the inner metal sheets represented a tire rubber and a rim of a wheel, respectively. Electric microphones were mounted in the inner and outer cavity. A hole was inserted at the bottom for a speaker 106 generating white noise. FIG. 2 (right panel) shows a side view of the same model with AMM shown applied to wheel barrel 112.

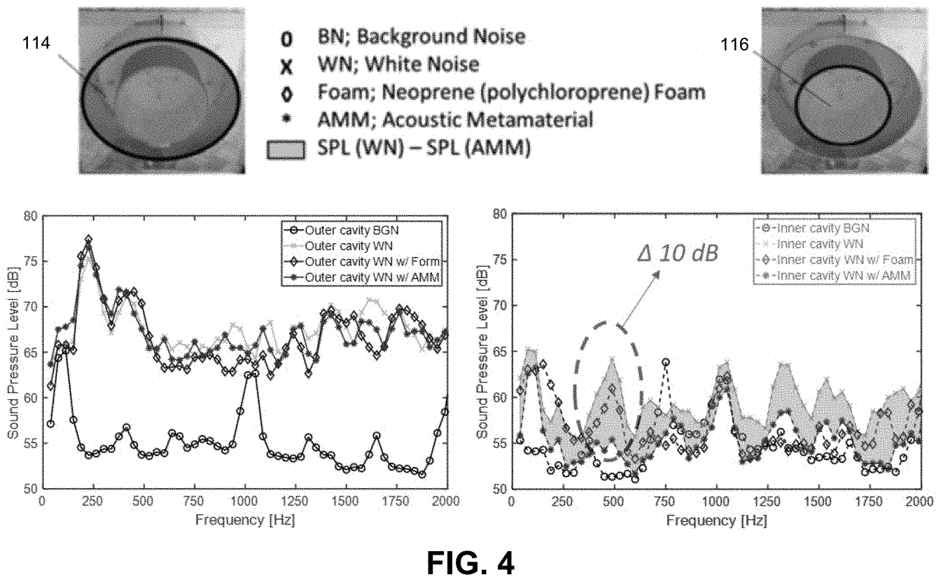

Some preliminary results of noise reduction are shown in FIG. 4, where the left panel shows acoustic spectrum for the outer (left, solid, 114) and inner (right, dashed, 116) cavities. Solid (dashed) lines with different markers show pressure spectra measured in the outer (inner) cavity for filling by different material structures. The 0 marker solid (dashed) line represents background noise and serves as a reference. Speaker generated white noise was turned on and spectra of empty outer and inner cavities were measured; these spectra are shown by x markers. Due to cylindrical symmetry of the tire cavity there are radial and azimuthal eigenmodes. The dominant contribution to automobile noise comes from the fundamental radial mode with frequency near 250 Hz. A peak was recorded near 250 Hz for all outer-cavity spectra in FIG. 4. Suppression of this peak in the inner-cavity spectrum strongly reduces noise transmitted to the car cabin.

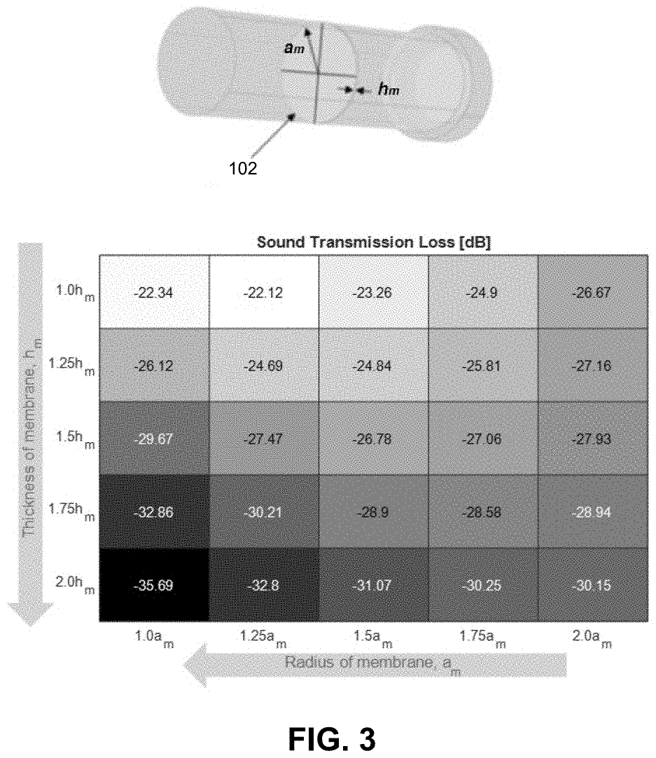

The efficiency of the existing technology of noise reduction was compared to experimental results by filling the cavity by a foam (⋄marker), with wrapping the same cavity by the proposed acoustic metamaterial (AMM) (* marker). The thickness of the foam layer and AMM was about 0.5 inches, but the AMM was lighter. Spectra in the right panel of FIG. 4 demonstrate that the noise in the inner cavity 116 is reduced in both cases. For the AMM the reduction was stronger, and it remained effective over a wider range of frequencies, with several minor peaks at higher frequencies. Additional optimization parameters are shown in FIG. 3 where an exemplary cell with thin membrane or plate 102 was used to obtain data.

### Example 3: Field Test

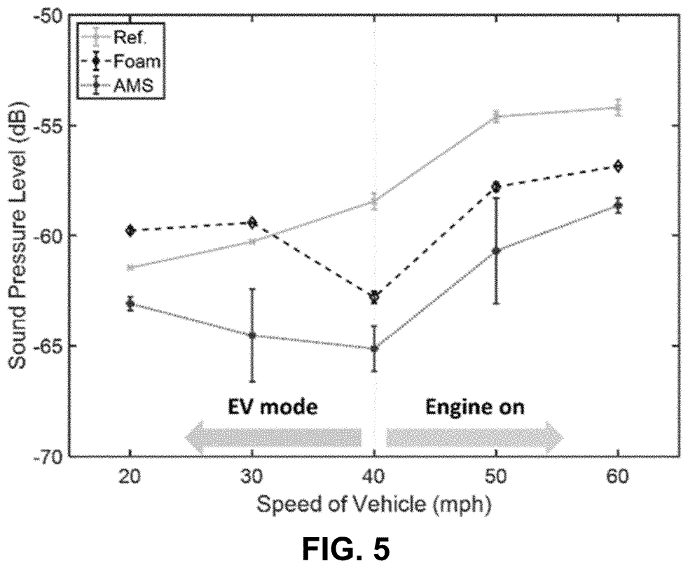

After the lab-scale test, a field test was performed with a Toyota Prius Hybrid, 2008 model. This car was chosen to minimize the noise induced by engine and exhaust and to focus on tire-pavement interaction. The tire size was 185/65 R15 and the air pressure in the tire was 44 psi. To investigate the effectiveness of AMM, three cases were considered at this time: (1) without any attachment, (2) with foam, and (3) with AMM. The test was performed on a local driveway, about 7.2 miles, with relatively new asphalt that was replaced in 2020. The noise inside the cabin was measured from 20 mph to 60 mph with 10 mph intervals. For 19 s, the temporal sound pressure was measured using a Rode NT-USB mini USB microphone and the recorded data was processed with FFT to provide a frequency spectrum of the sound pressure level. Specially, the frequency range from 200 to 300 Hz was focused on because the tire air cavity mode appears near 250 Hz. The average sound pressure level depending on the speed is shown in FIG. 5. Bright gray solid (*), black dashed (x), and dark gray dotted (⋄) lines (markers) refer to test without any attachment, test with foam, and test with AMM on the rim, respectively. FIG. 5 shows average values, so that the foam case displays more noise than the reference case. Through all speed ranges, AMM provided better noise reduction effects than foam. A cross-sectional diagram showing exemplary placement of the AMM in a tubeless automobile tire is provided in FIG. 6 showing overall tire radius 126, overall width 124, rim radius 130, section height 128, section width 122, and rim width 120 for reference. AMM 118 rests on barrel 112 in this example.

### Example 4: Effective Dynamic Mass Density of Membrane-Type AMM

When a sound wave propagates through a freely suspended structure, e.g., a panel, the incident wave is reflected at the interface, absorbed by a material, or transmitted to the other side while the sum of the total energy is still conserved. In the noise reduction problem, the sound transmission loss (STL), a logarithmic scale of the transmitted energy over the incident energy, is a measure of effectiveness. Sources of transmission loss include reflection and absorption. However, the reflection is usually oblivious to this problem. The conventional methods to reduce noise are based on the mass law. For general material, STL is a function of the surface mass density and frequency, as in Equation 1:

STL=20 log₁₀(fmₛ)−47.3 dB (1)

where f is frequency (Hz) and mₛ is surface mass density of the panel material.

A heavier material at a higher frequency provides a higher transmission loss. From the design perspective in transportation, increasing weight is critical because it needs more energy consumption. A different approach is necessary for better noise reduction of the sound generated at low frequency and the wideband noise.

One possible solution to overcome the intrinsic limitation is to use engineered materials. Acoustic metasurfaces (AMSes) or metalayers are artificially designed 2D materials of subwavelength thickness that can provide a non-trivial local phase shift and alter the incident wave's propagation direction. An AMS consisting of a thin rubbery panel and a relatively rigid cellular structure has shown over 200 times noise reduction for a specific frequency range and can be optimized for the desired application by modifying the geometry. Acoustic metamaterials consisting of a perforated, stiff, periodic pattern and thin, soft materials on a periodic structure can reduce noise significantly.

Here, a physical phenomenon of AMSes is distinguished from the conventional method as the noise reduction is caused by reflection due to the anti-local resonance rather than absorption. AMSes can be designed with a negative effective dynamic mass density (ρ_{eff}<0) when the frequency is below the fundamental frequency of a thin plate or panel. AMSes provide anti-resonance, out of phase with the incident wave and exponential decaying wave (Δd∝|ρ_{eff}^{-1/2}|), resulting in almost total reflection at the low broad frequency ranges.

As an example, highly reflective AMSes consist of a hexagonal unit cell and a clamped thin plate. Because the core panel is relatively rigid, when the noise occurs, the thin plate oscillates and propagates acoustic pressure while barely passing through the core panel. Through Rayleigh's method of a spring and a mass, the effective dynamic mass density, ρ_{eff}, can be determined using Equation 2.

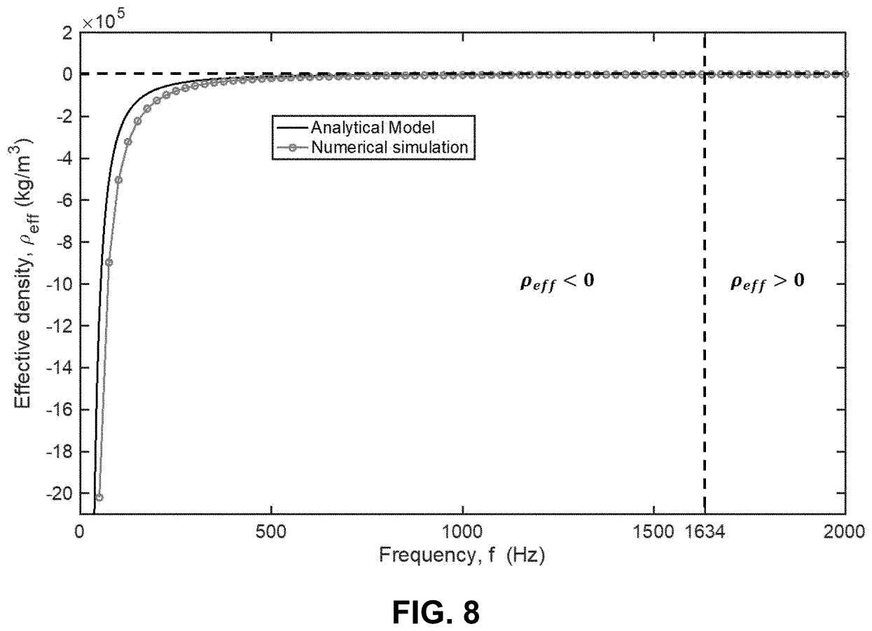

Effective dynamic mass density of an AMM including an elastomeric membrane or plate having a circular-shaped unit cell and an eigenfrequency of 1,634 Hz can also be evaluated using an analytical model and a numerical simulation (see FIG. 8). Effective dynamic density can be numerically obtained by dividing the out-of-plane surface averaged stress, σ̅_̅{̅y̅y̅}̅, by the product of the surface averaged acceleration, α̅_̅{̅y̅}̅, and the thin membrane thickness, hₘ, i.e., P_{eff}=σ̅_̅{̅y̅y̅}̅/(α̅_̅{̅y̅}̅hₘ) where the y-direction is the direction of wave propagation.

Effective dynamic mass density was determined using Equation 2:

$${ρ}_{eff} = {ρ}_{m} ( 1 - \frac{{f}_{r}^{2}}{{f}^{2}} ) \qquad ( 2 )$$

where fᵣ is the lowest eigenfrequency of a honeycomb- or circular-shaped thin plate, f is the sound frequency, and ρₘ is the thin plate's density. The given equation originates from Newton's second law, but the systems' dynamic inertial mass becomes a function of frequency due to the interactions between internal mass and spring.

If f<fᵣ, mass density is considered to be negative, where fᵣ is the lowest eigenfrequency of a circular shaped thin membrane and ρₘ is the density of the membrane. For the case of circular clamped thin membrane, fᵣ is calculated using the following equation:

$${f}_{r} = \frac{α}{2 π {a}_{m}^{2}} \sqrt{\frac{D}{ρ {h}_{m}}} , D = \frac{{E}_{m} {h}_{m}^{3}}{12 ( 1 - {v}_{m}^{2} )} \qquad ( 3 )$$

where hₘ is thickness of the membrane, aₘ is radius of the membrane, Eₘ and vₘ represent Young's modulus and Poisson's ratio of a material for the membrane, respectively, and α is a constant that depends on the number of nodal diameters n and the number of nodal circles s. Negative dynamic mass density implies that the local oscillation of the thin plate or membrane is out-of-phase to the incident wave, i.e., the direction of force and acceleration are opposing. Due to the local anti-resonance, AMM provides a large transmission loss, almost total reflection for the low frequency airborne sound.

In the case of the hexagonal clamped thin plate, fᵣ is calculated using the following equation:

$${f}_{r} = \frac{π α}{6 {a}_{m}^{2}} \sqrt{\frac{D}{ρ {h}_{m}}} , D = \frac{{E}_{m} {h}_{m}^{3}}{12 ( 1 - {v}_{m}^{2} )} \qquad ( 4 )$$

where hₘ is the thickness of the thin plate, and aₘ is the side length of the thin hexagonal plate. Eₘ and vₘ represent Young's modulus and Poisson's ratio of base material for the thin plate, respectively. The constant α is a nondimensional frequency parameter calculated by the energy approach and convergence study. For the first mode, α is 3.9068. If f<fᵣ, the frequency-dependent effective dynamic mass density becomes negative. This implies that the force and the acceleration have the opposite direction. The clamped thin plate's local oscillation provides the anti-resonance, which is out of phase with the incident wave. Therefore, the acoustic wave through the thin plate ceases to propagate and becomes evanescent, as the negative density implies an imaginary wave vector.

Alternate model. An alternate model of AMS-based noise reduction has previously been proposed and uses the mass law and the rigidity law with regard to the effect of resonance and stiffness and modified the mass law as follows:

$$STL = 20 {log}_{ 10} ( 4 {π}^{2} \cdot {m}_{s} \cdot f - \frac{K}{f} ) - 43 dB \qquad ( 5 )$$

where K is a surface rigidity and mₛ is a surface mass density of a thin panel. This expression is similar to Sharp's model (1973), which took into account the effect of bending resonance of a thin panel and its stiffness to determine STL. This alternate model indicates that the noise reduction, absorption only, is induced by the resonance of the panel rather than reflection due to the negative effective mass density. Thus, this model allows for the determination of a frequency boundary, but it does not offer an explanation of the reason for the noise reduction at the wideband and low frequencies, and the modeling presented in this disclosure offers a more complete description of noise reduction at the wideband and low frequencies.

### Example 5: Sound Transmission Loss

Sound transmission loss (STL) was evaluated for a unit cell of an AMM with accompanying elastomeric thin plate or membrane. The numerical simulation result was plotted (see FIG. 7). Without AMM, there is no STL. However, by the local anti-resonance, STL for the AMM construction was about 31 dB between 50 and 2,000 Hz. (see FIG. 7).

### Example 6: Design and Fabrication of Acoustic Metasurfaces (AMSes)

### Design

The fundamental frequency, f, of tire cavity is a function of the speed of sound of air, c, and wavelength, λ; f=c/λ=2c/π(Dₒ+Dᵢ), where Dₒ is the outer diameter of the tire cavity toroid and Dᵢ is the inner diameter of tire cavity toroid. For general passenger vehicles, the cavity mode is near 230 Hz, which needs to be reduced.

Highly reflective AMSes were explicitly designed for this frequency range, as shown in FIG. 1. AMSes are fabricated using silicone rubber and composed of a honeycomb-shaped core panel attached to a tire's rim. Hexagonal unit cell-shaped metasurfaces have a natural mode of oscillation at high frequencies than squares and triangles with identical unit cells with the hydraulic diameters. Moreover, the shape and form of the periodic metasurfaces with hexagonal unit cells are not deformed across a tire's curved plane. Hexagonal unit cell-shaped metasurfaces also offer the best surface filling fraction, which is ideal for noise suppression. The unit cell can be considered as a clamped thin plate because the core panel is relatively rigid. Thus, when the noise occurs, the thin plate only oscillates and propagates acoustic pressure while barely passing through the core panel. The unit cell's effective property with hexagonal cross-section was evaluated to predict the AMS's acoustic characteristics. Using Rayleigh's method of a spring and a mass, the effective dynamic mass density, ρ_{eff}, can be determined using Equation 1 (above), while fᵣ can be calculated using Equation 2 (above). For the first mode of the system with the hexagonal unit cell-shaped metasurfaces, α is 3.9068. If f<fᵣ, the frequency-dependent effective dynamic mass density becomes negative. It implies that the force and the acceleration have the opposite direction. The clamped thin plate's local oscillation provides the anti-resonance, which is out-of-phase with the incident wave. Therefore, the acoustic wave through the thin plate ceases to propagate and becomes evanescent since the negative density implies an imaginary wave vector.

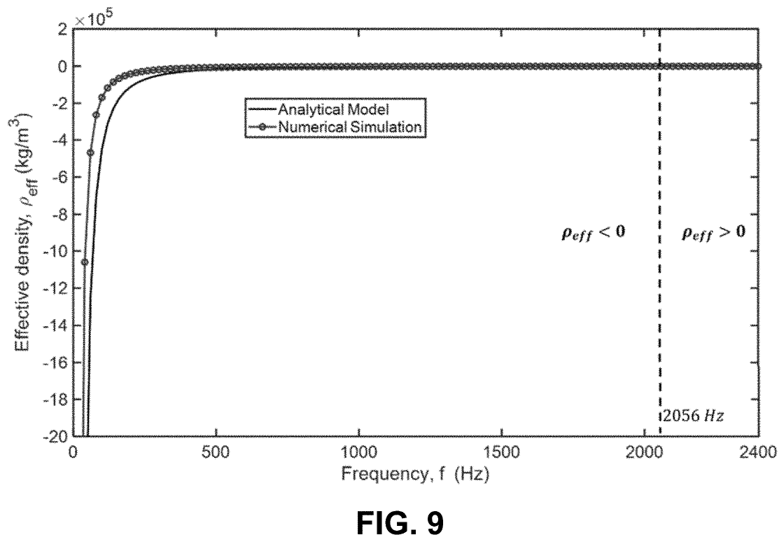

The effective dynamic mass density of an AMS including an elastomeric thin plate having an eigenfrequency of 2,056 Hz and a hexagonal unit cell was obtained from Equation 1 and the numerical simulation using COMSOL Multiphysics when hₘ=0.5 mm, Eₘ=7 MPa, ρₘ=1,070 kg/m³, vₘ=0.49, and aₘ=3.65 mm (see FIG. 9). The effective dynamic density can be numerically obtained by dividing the out-of-plane surface averaged stress, σ̅_̅{̅y̅y̅}̅, by the product of the surface averaged acceleration, α̅_̅{̅y̅}̅, and the thin plate thickness, hₘ, i.e., ρ_{eff}=σ̅_̅{̅y̅y̅}̅/(a̅_̅{̅y̅}̅hₘ) where the y-axis is the direction of wave propagation.

### Field Test

To demonstrate the noise reduction of AMSes, we used a tire cavity model with AMSes, conducting a field test with tires covered with AMSes to prove the noise reduction capability. Based on the parametric study, we first fabricated AMSes made up of a commercial honeycomb core panel, aramid—⅛ in (3.2 mm) cell with 3 lb/ft³ (48 kg/m³) density and ¼ in (6.4 mm) thickness, from ACP Composites and silicone rubber Dragonskin from Smooth-On, Inc. The silicone rubber was poured on the clean surface of a wood plate, which was prepared with a 1 mm deep channel utilizing a CNC router, as evenly as possible, then smoothed over with an 11 in. paint shield which rested on the edges of the channel, resulting in the thickness of the silicone rubber about 1 mm. Next, the quarter-inch-thick honeycomb core panel is put on the rubber layer and cured for 2 hours at room temperature, i.e., the silicone rubber covered one side of the panel.

The manufactured AMSes were attached to the inner layer of the tire cavity model mimicking a real tire, 235/65R18, for the lab test referring to a previously published design and the rim of each tire (Pirelli Tires) 185/65R15, of a Toyota Prius Hybrid 2008 vehicle for the field test. The tire cavity model consisted of medium density fiberboard (MDF), aluminum metal sheets, and acrylic panel, as shown in FIG. 2 (left). The outer and the inner metal sheets represent a tire rubber and a rim of a wheel, respectively. We added a rubber seal to the edge of the aluminum sheets to isolate the cavity. A Rode NT-USB mini microphone, which has a sampling rate of 48 kHz and a frequency range of 20 Hz-20 kHz, was mounted in the center of the inner cavity and connected to the computer with the USB cable. A hole was inserted at the bottom for a speaker emitting white noise generated by a Minirator MR2 audio generator of NTi Audio, which has a resolution of 0.1 Hz.

For the field test, AMSes were bonded on the rim, inside each tire of the vehicle (see FIG. 2). As a comparison, a commercial neoprene sponge foam rubber from Lazy Dog Warehouse was used for soundproofing with the same thickness of the honeycomb core panel.

### Design Map of the Unit Cell of AMS

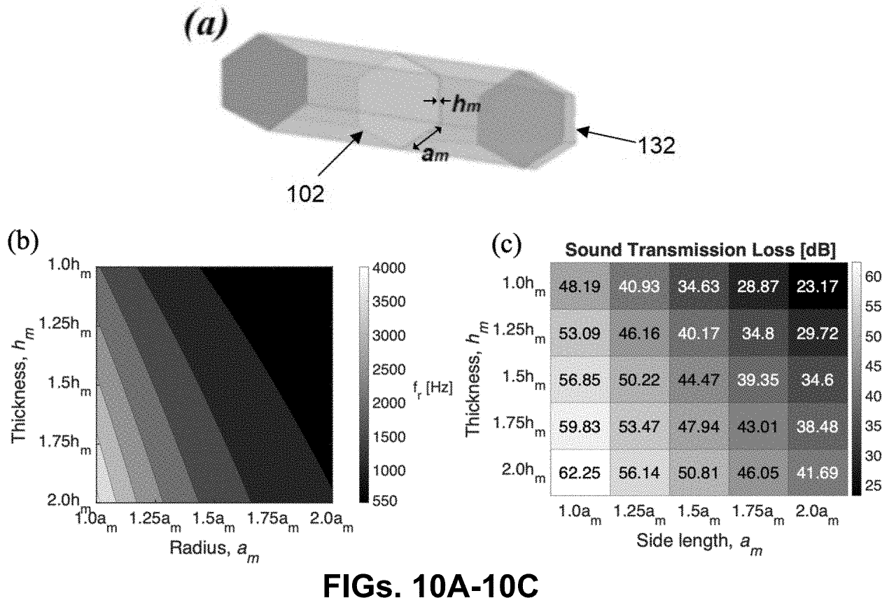

A parametric study of the unit cell was conducted to evaluate the effect of design parameters, such as side length and thickness of the unit cell's thin plate, density, and sound transmission loss (STL) (see FIGS. 10A-10C). Then, AMSes were fabricated based on the parametric study to maximize STL yet remain lightweight and attached to the tire cavity model and a real tire for the laboratory and field tests. The AMSes' performance was compared to a commercial foam having the same thickness as that of AMSes.

A parametric study of a hexagonal unit cell was carried out using the numerical simulation (COMSOL Multiphysics, acoustic module) to predict design parameters' effect on acoustic properties, such as dynamic mass density and STL. As the design parameters, thickness (hₘ) and side length (aₘ) of the thin plate were examined. A clamped hexagonal thin plate was considered the unit cell of AMS, and the linear elastic model for the silicone rubber was occupied. FIG. 10A illustrates the unit cell's geometry, where the thin plate 102 is placed in the middle of the pipe which can optionally end with or incorporate perfectly matched layer(s) (PML) 132. The PML is placed on the back of the receiver side to avoid the reflection from the wall. On top of the pipe, the acoustic pressure propagates through the structure. Then, the transmitted sound pressure was measured at the bottom.

The noise's peak is near 230 Hz, which is the fundamental mode of the tire cavity. The investigation's frequency range was from 100 Hz to 400 Hz to consider the effects on the fundamental mode. As mentioned above, when the frequency is less than the fundamental mode, the effective density of AMSes becomes negative. Under these conditions, the plate's local oscillation reflects the incident wave results in a substantial noise reduction. Therefore, when the natural frequency is shifted to a higher frequency by modifying the design parameters, the noise reduction effect is enhanced (see FIGS. 10B-10C). The AMS shows a significant noise reduction by 23-62 dB at the low-frequency ranges even though the silicone rubber's material properties were simplified using a linear elastic model in this study. A smaller unit cell and a thicker plate have even higher sound losses because the first mode is proportional to the thickness and inversely proportional to the plate's area (see Equation 2).

### Sound Pressure Level in Tire Cavity Model (Static Test)

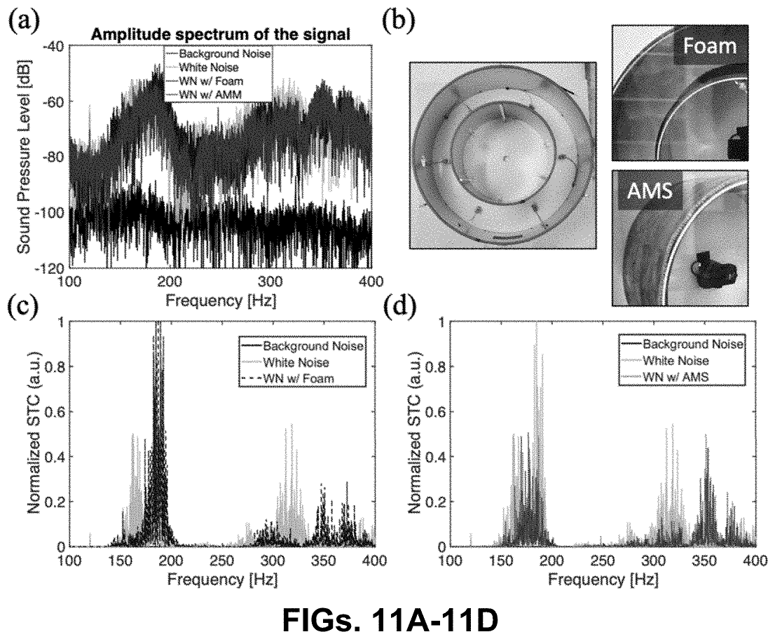

The AMS feasibility was demonstrated by constructing a tire-cavity that represented an actual tire (235/65R18), as shown in FIG. 2. The model consisted of MDF, aluminum metal sheets, and acrylic panels. The outer and the inner metal sheets represent a tire rubber and a rim of a tire, respectively. The Rode NT-USB mini microphone is mounted in the inner cavity. A hole at the bottom of the speaker facilitated the generation of white noise. FIGS. 11A-11D show the effect of noise reduction due to the AMSes, where FIG. 11A shows the acoustic spectrum in log scale, and FIGS. 11C-11D depict the sound transmission coefficients (STCs) normalized to the maximum sound transmission of the white noise of the cavity mode. FIG. 11B illustrates the tire cavity with foam and AMS.

In FIG. 11A, the solid black line represents background noise and serves as a reference. The speaker generating white noise (W.N.) was turned on to measure the empty inner cavity's spectra and is depicted by the bright gray lines. Due to the circular symmetry of the tire cavity, there are radial and azimuthal eigenmodes. The dominant contribution to automobile noise originates from the fundamental radial mode with a frequency near 184.7 Hz. There is a peak near 185 Hz in FIG. 11A. The suppression of this peak noise in the frequency spectrum within the inner cavity strongly reduces the noise transmitted to the car's cabin. The efficiency of our metasurface based technology is compared with existing sound absorption-based noise reduction technology. The noise in a cavity filled with ¼ in (˜6.4 mm) thick form (shown by dark gray dashed lines) is compared with the cavity wrapped using the acoustic metasurface (shown by the bright gray dotted lines). It is evident from the acoustic spectra shown in FIGS. 11C-11D that the noise within the inner cavity is reduced in both cases. For the AMS, the reduction is more substantial, especially near the cavity mode, and it remains effective over a broader range of frequencies. The bandwidth of the noise suppression frequency is narrower for the foam as it still transmits sound energy while absorbing due to thermal dissipation. The wavelength at the low frequency is much larger than the porous size of the foam. However, the AMS reflects due to anti-local resonance below the natural frequency of the thin plate. There are several minor peaks at higher frequencies at 350 Hz, and the unit cell design can suppress that. Because the dynamic mass density is a function of design parameters, the modes can be varied or specified to reflect, i.e., noise reduction.

### Sound Pressure Level in the Cabin (Dynamic Test)

After the lab-scale test, the field test was performed with the Toyota Prius Hybrid 2008 vehicle. This car was chosen to minimize the noise induced by engine and exhaust and focus on tire-pavement interaction. The Prius Hybrid has E.V. mode up to 60 km/h (˜37 mph). The tire size is 185/65R15 (Pirelli Tire), and the air pressure in the tire is 44 psi (˜303 kPa). To investigate the effectiveness of AMS, we consider three cases—i) without any attachment, ii) with foam, and iii) with AMS. The test was performed on the local driveway, about 7.2 miles (11.6 km), with relatively new asphalt replaced in 2020. The noise inside the cabin was measured twice from 20 (˜32 km/h) to 60 mph (˜97 km/h) with a 10 mph (˜16 km/h) interval.

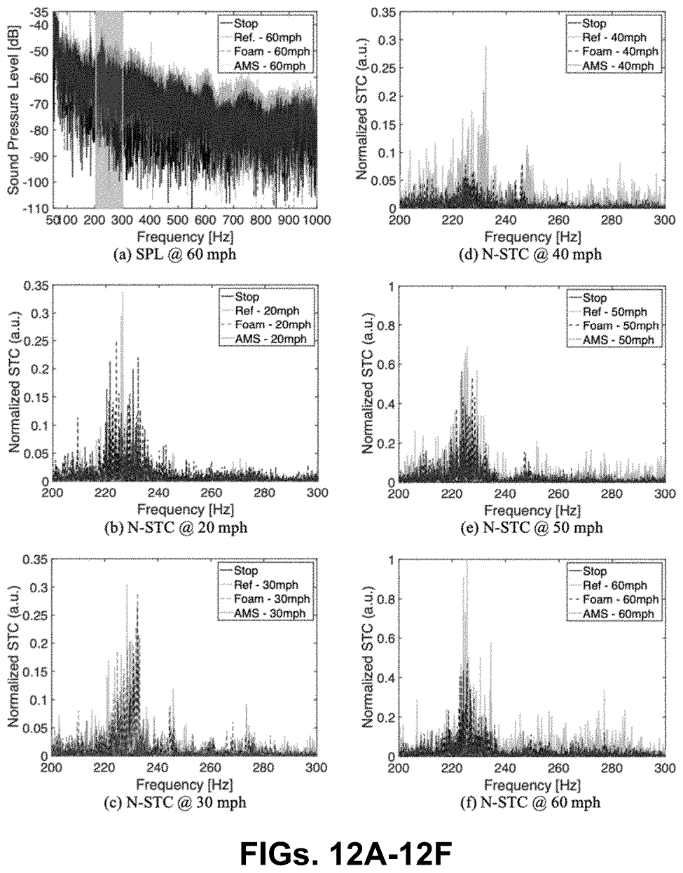

The temporal sound pressure was measured for 19 seconds with a Rode NT-USB mini microphone, and the recorded data were processed with the fast Fourier transform (FFT) to obtain the frequency spectrum of the sound pressure level (SPL) from 50 Hz to 1,000 Hz as shown in FIG. 12A. The cavity mode occurs near 230 Hz, as expected. Although both foam and AMS show noise reduction effect, the SPL of AMS is 2-3 dB more than foam and is significantly higher. The frequency range under consideration ranged from 200 to 300 Hz as the tire air cavity mode appears near 230 Hz. The frequency spectrum of the sound transmission coefficient (STC) at various vehicle speeds is shown in FIGS. 12B-12F. The maximum peak normalizes STC for the cavity mode at 60 mph (˜97 km/h). For low speed at E.V. mode, 20-40 mph (˜32-64 km/h), the cavity mode's peak values are similar, but the noise at other frequencies induced by engine noise increases when the vehicle speed is increased gradually.

The average sound pressure level depending on the vehicle speed, as shown in FIG. 5. The noise level increases with the speed while the slope of noise changes when the mechanical engine kicks on after 40 mph (˜64 km/h) due to the electric to gasoline power modes. It is the average value so that the foam case shows more noise than the reference case. Although the foam reduces the cavity mode's noise, more peaks occur near the cavity mode, as seen in FIG. 12B. AMS is about 1.45× heavier than foam. Nevertheless, through all speed ranges, it clearly shows that AMS provides a better noise reduction effect than foam, 2-5 dB near the cavity mode, 200-300 Hz.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Assouar, B. et al, Acoustic metasurfaces, Nat. Rev. Mater. 2018, 3:460-472.
2. Braun, M. E. et al, Noise source characteristics in the ISO 362 vehicle pass-by noise test: Literature review, Appl. Acoust., 2013, 74:1241-1265.
3. Choi, S.-J. et al, Polyurethane foam and pneumatic tire, 2016, U.S. Pat. No. 9,315,611.
4. Cusimano, F. J., Low noise pneumatic tire tread with voids balanced over each half tread region, 1993, U.S. Pat. No. 5,209,793.
5. Domenichini, L. et al, Relationship between road surface characteristics and noise emission, First International Colloquium on Vehicle Tire Road Interaction, 1999, Rome, Italy, Pap. 99.03.
6. Jin, C. et al, Study on tire noise transfer path identification, in: Int. Conf. Signal Process. Proceedings, 2010, <https://doi.org/10.1109/ICOSP.2010.5656122> accessed Jan. 5, 2021.
7. Kamiyama, Y. et al, VEHICLE WHEEL HAVING SOUND—DAMPING STRUCTURES, 2018, U.S. Pat. No. 10,131,190.
8. Li, T. et al, The effects of tread pattern on tire pavement interaction noise, in: Proceedings of the Inter-Noise 2016: 45th International Congress and Exposition on Noise Control Engineering Towards a Quieter Future, August 21-24, 2016, Hamburg, Germany, Volume 1, p. 2185.
9. Li, Y. et al, Metascreen-Based Acoustic Passive Phased Array, Phys. Rev. Appl., 2015, 4, Article ID 024003.
10. Liew, K. M. et al, A set of orthogonal plate functions for flexural vibration of regular polygonal plates, J. Vib. Acoust. Trans. ASME., 1991, 113:182-186.
11. Ma, G. et al, Acoustic metasurface with hybrid resonances, Nat. Mater., 2014, 13:873-878.
12. Mohamed, Z. et al, A study of tyre cavity resonance and noise reduction using inner trim, Mech. Syst. Signal Process., 2015, 50-51:498-509.
13. O'Boy, D. J. et al, Automotive tyre cavity noise modelling and reduction, in: Proc. INTER-NOISE 2016—45th Int. Congr. Expo. Noise Control Eng. Toward a Quieter Future, 2016, Loughborough University. Conference contribution, <https://hdl.handle.net/2134/22561> accessed Jan. 5, 2021.
14. Rayleigh, L., Theory of Sounds, Macmillan & Co., London, UK, 1877.
15. Sakakibara, K., PNEUMATIC TIRE, 2018, U.S. Pat. No. 10,000,096.
16. Sharp, B. H., A Study of Techniques to Increase the Sound Insulation of Building Elements, Wyle Laboratories Report, WR 73-5, Wyle Laboratories Research Staff, El Segundo, Calif., 1973. Distributed as PB-222 829, National Technical Information Service, United States Department of Commerce, Springfield, Va.
17. Sui, N. et al, A lightweight yet sound-proof honeycomb acoustic metamaterial, Appl. Phys. Lett., 2015, 107:216101.
18. Tezuka, T., TIRE TREAD FOR REDUCING NOISE, 2017, WO 2017/002320.
19. The European Parliament and the Council of the European Union, REGULATION (EU) No 540/2014 OF THE EUROPEAN PARLIAMENT AND OF THE COUNCIL of 16 Apr. 2014—On the sound level of motor vehicles and of replacement silencing systems, and amending Directive 2007/46/EC and repealing Directive 70/157/EEC, Off. J. Eur. Union. 158, 2014, 131-195.
20. Timoshenko, S., Vibration Problems in Engineering, D. van Nostrand Company, Inc.: New York, N.Y., 1928.
21. Wang, X. et al, A study of tyre, cavity and rim coupling resonance induced noise, Int. J. Veh. Noise Vib., 2014, 10, 25-50.
22. Xie, Y. et al, Wavefront modulation and subwavelength diffractive acoustics with an acoustic metasurface, Nat. Commun., 2014, 5, Article ID 5553.
23. World Health Organization, Burden of disease from environmental noise, 2011, 128pp, <https://www.who.int/quantifying_ehimpacts/publications/e94888.pdf?ua=1>, accessed Oct. 19, 2020.
24. Yang, Z. et al, Membrane-type acoustic metamaterial with negative dynamic mass, Phys. Rev. Lett., 2008, 101, Article ID 204301.

What is claimed is:

1. A road noise reducing system comprising:
(a) a wheel rim comprising a barrel;
(b) a first layer of acoustic metamaterial comprising a first plurality of open cells mounted on the barrel; and
(c) optionally, a second layer of acoustic metamaterial comprising a second plurality of open cells in contact with the first layer of acoustic metamaterial.

2. The road noise reducing system of claim 1, further comprising:
(d) a pneumatic tire comprising a hollow,
wherein the tire is mounted on the wheel rim such that the hollow forms a closed cavity.

3. The road noise reducing system of claim 2, further comprising a noise-absorbing foam in the hollow of the pneumatic tire.

4. The road noise reducing system of claim 1, wherein the first layer of acoustic metamaterial, the second layer of acoustic metamaterial if present, or both comprise a meta-aramid paper and a phenolic resin.

5. The road noise reducing system of claim 1, wherein the first layer of acoustic metamaterial, the second layer of acoustic metamaterial if present, or both independently have a thickness of from about ⅛ in (3.2 mm) to about 2 in (50.8 mm) and a density of from about 1.5 pcf (24 kg/m³) to about 16 pcf (257 kg/m³).

6. The road noise reducing system of claim 1, wherein the first plurality of open cells, the second plurality of open cells if present, or both comprise unit cells having a triangular shape, a square shape, a circular shape, a hexagonal shape, a rectangular shape, or any combination thereof.

7. The road noise reducing system of claim 6, wherein the unit cells have a hexagonal shape and a side length of from about 1 mm to about 10 mm.

8. The road noise reducing system of claim 1, further comprising an elastomeric membrane, wherein the elastomeric membrane comprises silicone, a natural latex, a synthetic latex, neoprene, ethylene propylene diene monomer (EPDM) rubber, nitrile, styrene-butadiene rubber (SBR), natural rubber, polyurethane, a fluoroelastomer, isobutylene-isoprene, or any combination thereof.

9. The road noise reducing system of claim 1, wherein the road noise reducing system has an effective dynamic mass density of less than about 0 kg/m³ at frequencies of from about 50 Hz to about 2,000 Hz.

10. The road noise reducing system of claim 1, wherein the barrel of the wheel rim further comprises a groove and a resonator mounted in the groove, and wherein the first layer of acoustic metamaterial contacts the resonator.

11. The road noise reducing system of claim 1, wherein the road noise reducing system has a sound transmission loss of at least 20 dB at frequencies of from about 50 Hz to about 2,000 Hz.

12. The road noise reducing system of claim 1, wherein tire-road interaction noise is reduced by at least about 50% compared to a control not using the road noise reducing system.

13. A method for making a road noise reducing wheel and tire assembly, the method comprising:
(a) providing a wheel rim comprising a barrel;
(b) contacting the barrel with a first layer of acoustic metamaterial comprising a first plurality of open cells mounted on the barrel;
(c) optionally, contacting the first layer of acoustic metamaterial with a second layer of acoustic metamaterial comprising a second plurality of open cells;
(d) mounting a pneumatic tire comprising a hollow on the wheel rim such that the hollow forms a closed cavity; and
(e) inflating the tire.

14. The method of claim 13, wherein the first layer of acoustic metamaterial, the second layer of acoustic metamaterial if present, or both, comprise a meta-aramid paper and a phenolic resin.

15. The method of claim 13, wherein the first layer of acoustic metamaterial, the second layer of acoustic metamaterial if present, or both, independently have a thickness of from about ⅛ in (3.2 mm) to about 2 in (50.8 mm) and a density of from about 1.5 pcf (24 kg/m³) to about 16 pcf (257 kg/m³).

16. The method of claim 13, wherein the first plurality of open cells, the second plurality of open cells if present, or both comprise unit cells having a triangular shape, a square shape, a circular shape, a hexagonal shape, a rectangular shape, or any combination thereof.

17. The method of claim 16, wherein the unit cells have a hexagonal shape and a side length of from about 1 mm to about 10 mm.

18. The method of claim 13, further comprising:
(f) contacting the first layer of acoustic metamaterial, the second layer of acoustic metamaterial if present, or both with an elastomeric material; and
(g) curing the elastomeric material to form an elastomeric membrane.

19. The method of claim 18, wherein the elastomeric membrane comprises silicone, a natural latex, a synthetic latex, neoprene, ethylene propylene diene monomer (EPDM) rubber, nitrile, styrene-butadiene rubber (SBR), natural rubber, polyurethane, a fluoroelastomer, isobutylene-isoprene, or any combination thereof.

20. A wheel and tire assembly produced by the method of claim 13.
